(19) United States
(12) Patent Application Publication
(10) Pub. No.: US 2007/0264614 A1
(43) Pub. Date: Nov. 15, 2007

(54) Playaz Dental Grillz

(76) Inventor: Yong Hwan Kim, Hoffman Estates, IL (US)

Correspondence Address: Yong Hwan Kim, 5571 McDonough Road, Hoffman Estates, IL, 60192, US

(21) Appl. No.: 11/433,884

(22) Filed: May 15, 2006

(51) Int. Cl. A61C 5/00

(52) U.S. Cl. 433/215

(57) ABSTRACT

Playaz Dental Grillz are dental fixtures that enable a custom fit without the need of user molding. The use of surgical metals, silicon padding, UV coating and a unique 4 prong attachment enable this safely. The use of 24K gold or Rhodium plating and cubic zirconium provide a jewelry image and it is being marketed as a temporary fashion look.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND

Other dental fashion jewelry fixtures have been designed in a more permanent fashion with adhesives and welds. Single tooth fixtures were made popular in recent years by musicians and utilize either dental surgery similar to crowns or caps to place jewelry style components over a tooth for fashion rather than need. These methods are extreme and expensive, but there was a market demand for a cheaper, less invasive dental jewelry alternative.

### BRIEF SUMMARY

Playaz Dental Grills offers a full-smile, non-invasive alterative to expensive permanent dental appliances. Using a unique tension fit with 4 silicon coated prongs to remain snug in your mouth and a malleable metal to enable a more custom fit. Silicon padding is used to prevent any metal from coming in contact with the teeth and is unique to our product.

### BRIEF SUMMARY OF THE SEVERAL VIEWS OF THE DRAWINGS

FIG. 1A—This drawing demonstrates a view from all four sides of the One Piece Design. Note the placement of the Silicon forming bar and back prongs which are all necessary to ensure proper fitting of the device.

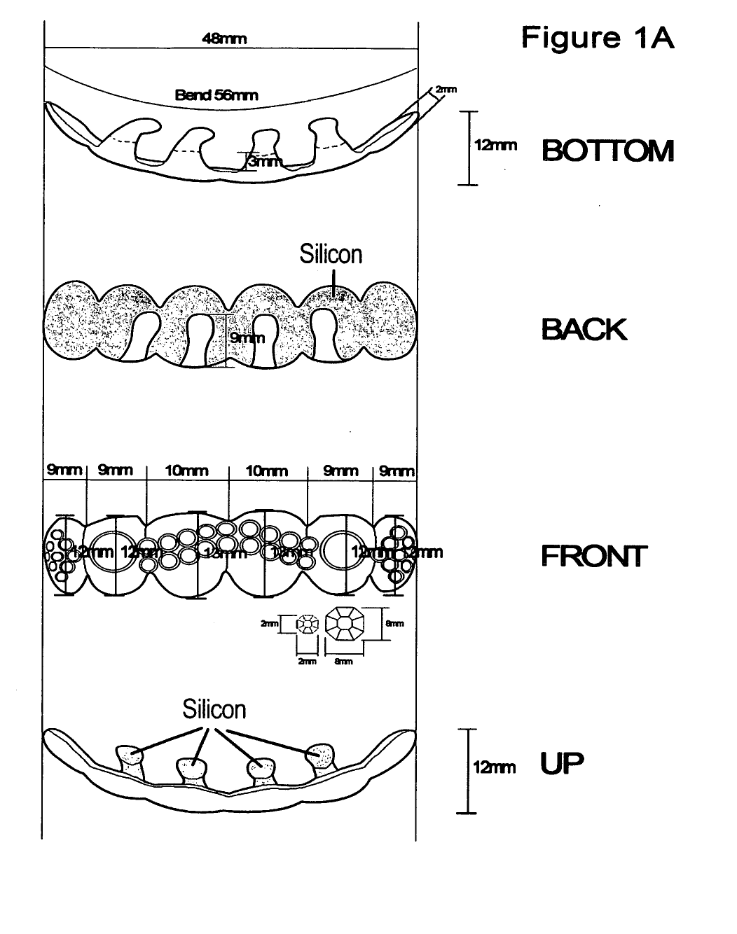

FIG. 2A—This drawing demonstrates a view from all four sides of the Separation Design. The front view isolates the placement of cubic zirconium in one particular design chosen for the drawing. Note in the drawings the curvature of the item which is necessary for proper fitting in the mouth.

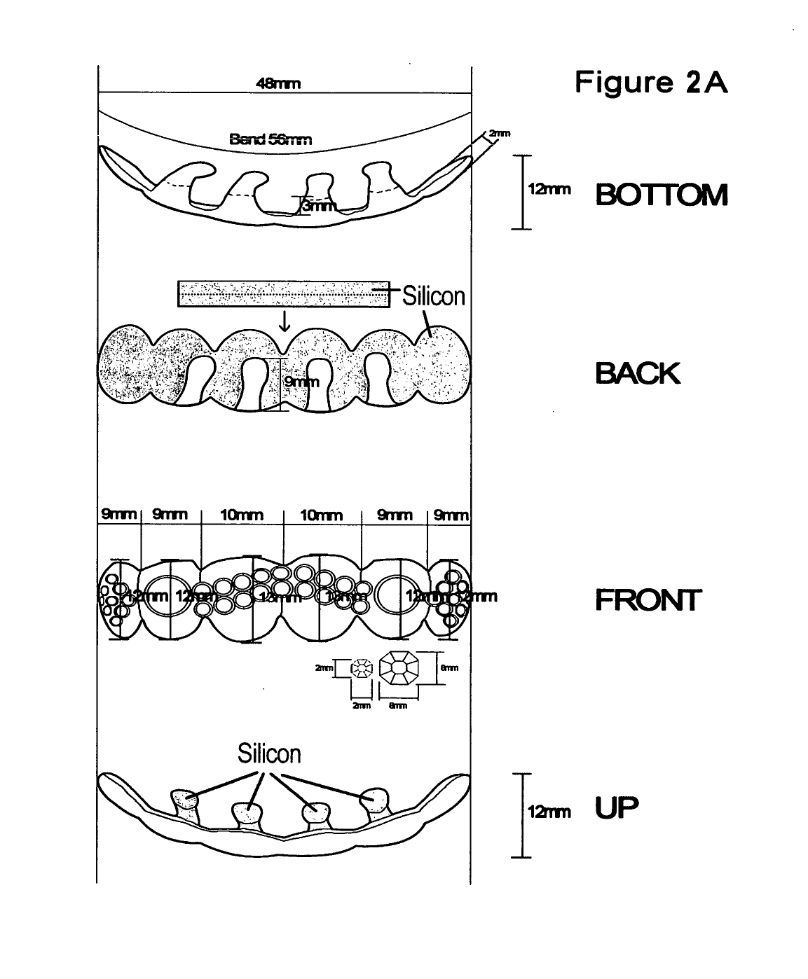

FIG. 3A—This drawing provides the dual instructions used for both designs of Playaz Dental Grillz for reference.

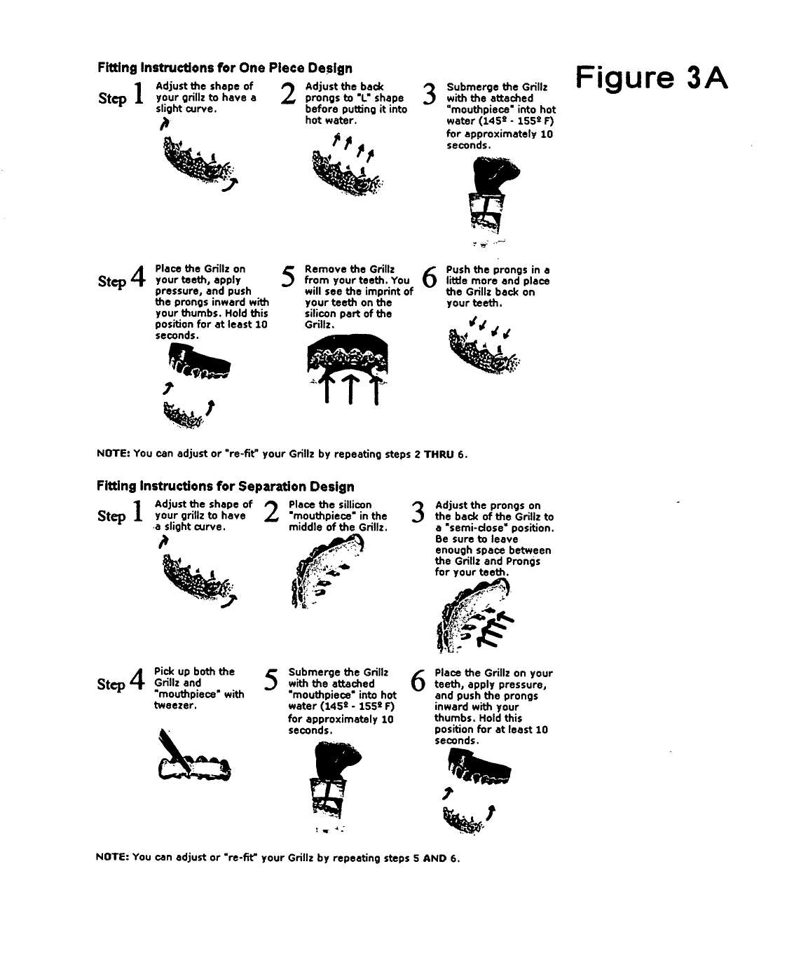

### DETAILED DESCRIPTION

Playaz Dental Grillz are manufactured from surgical metals and plated with 24K Gold or Rhodium to prevent color change. They are then overlaid with silicon padding and a layer of UV coating to prevent any padding from flaking or peeling. The UV coating and padding both ensure that the user is protected from any contact with metal in their mouth.

Four prongs are placed based upon typical teeth configuration. These prongs are then used to enable the user to get a snug yet comfortable fit. These prongs are also plated and UV coated. This unique prong configuration enables a one size fits all methodology and also enables an upper or lower tooth placement.

Cubic Zirconias are placed in several designs on the mold to provide for fashion trends and then UV coated. This coating ensures that the zirconium will not come off and again provides for user comfort.

Fashion offerings will be improved with the addition of solid gold and sterling silver in the future. Improvements to the plastic materials are being researched.

1. Malleable form enables custom sizing or one size fits all users without the need for fitting or molding to the user.

2. Padding utilizing silicon protects user from metal contact in the mouth and provides comfort.

3. UV coating to prevent padding and cubic zirconium from coming loose and to meet requirements for oral fixtures.

4. Four Fitting Prongs secure the piece and provide for a custom fit; prongs are silicon coated to further protect the user from any metal contact.

5. Surgical grade metals plated with 24K gold or Rhodium to provide for quality and health codes for dental fixtures.
